(19) United States
(12) Patent Application Publication
(10) Pub. No.: US 2016/0119151 A1
(43) Pub. Date: Apr. 28, 2016

(54) METHOD AND SYSTEM FOR DETECTING MISBEHAVIOR FOR VEHICLE-TO-ANYTHING COMMUNICATION

(71) Applicants: HYUNDAI MOTOR COMPANY, Seoul (KR); Kia Motors Corporation, Seoul (KR); Penta Security System Inc., Seoul (KR)

(72) Inventors: Jong Rok PARK, Seoul (KR); Cho Rong RYU, Incheon (KR); Dae Sung HWANG, Hwaseong-si (KR); Su Lyun SUNG, Anyang-si (KR); Dong Gyu NOH, Dongducheon-si (KR); Hahk Rel NOH, Bucheon-si (KR); Duk Soo KIM, Seoul (KR); Sang Gyoo SIM, Seoul (KR); Eun Ho SHIN, Seoul (KR); Jung Bai KIM, Seoul (KR); Byung Gwan KIM, Seoul (KR); Seok Woo LEE, Seoul (KR); You Sik LEE, Suwon-si (KR)

(21) Appl. No.: 14/656,593

(22) Filed: Mar. 12, 2015

(30) Foreign Application Priority Data
Oct. 22, 2014 (KR) 10-2014-0143496

(51) Int. Cl. H04L 9/32

(52) U.S. Cl. CPC H04L 9/3268

(57) ABSTRACT

A method for issuing a reliable certificate to a vehicle for a vehicle-to-anything (V2X) communication in a server on a network comprises receiving a certificate issue request including vehicle identification information and road-side unit (RSU) identification information from an RSU. Log information for the certificate issue request is extracted from a database. Normality or abnormality is determined according to whether a predetermined certificate issue criteria is satisfied by analyzing the certificate issue request and the log information. The certificate is issued and the certificate is transmitted to a vehicle communication module according to determination of normality, or certificate revocation information is registered according to determination of abnormality.

### CROSS-REFERENCE TO RELATED APPLICATION

This application is based on and claims the benefit of priority to Korean Patent Application No. 10-2014-0143496, filed on Oct. 22, 2014 in the Korean Intellectual Property Office, the disclosure of which is incorporated herein in its entirety by reference.

### TECHNICAL FIELD

The present disclosure relates to a method and system for detecting misbehavior for a vehicle-to-anything (V2X) communication, and more particularly, to a method and system for actively validating an anonymous certificate issue request in a server and detecting the misbehavior such as an attack by other vehicles, etc. in a V2X communication using a wireless access in vehicular environment (WAVE) communication method.

### BACKGROUND

IEEE 1609.2 among IEEE 1609 series is the standard for a wireless access in vehicular environment (WAVE), which defines for a security framework. In order to detect misbehavior of an anonymous certificate issue, a protocol exchanging a misbehavior report has been somewhat discussed, but details for determining what is misbehavior in central validation for a certificate request and the like have not been defined. Currently, since a V2X communication using the WAVE has not been commercialized, there is no clear related art available.

Thus, a stable method for defining detailed items for an active anonymous certificate issue and misbehavior, etc. in a server and issuing a certificate to a lawful entity is required.

### SUMMARY

An aspect of the present inventive concept provides a method and system for actively validating an anonymous certificate issue request by central validation and detecting misbehavior such as being attacked by other vehicles, and the like, in a V2X communication environment in which on board unit (OBU) based on WAVE abiding by IEEE 1609.2 and public key infrastructure (PKI) system based on an infra are established.

Another aspect of the present inventive concept provides a method and system for detecting misbehavior capable of providing a stable V2X communication environment, so that an anonymous certificate issue request, an anonymous certificate reception and a misbehavior report, etc. in a vehicle are transmitted to a server through a road-side unit (RSU) and a certificate can be issued to a lawful entity by determining whether the request is normal and detecting misbehavior such as the attack by other vehicle, etc. in the server.

According to an exemplary embodiment of the present inventive concept, a method for issuing a reliable certificate to a vehicle for a vehicle-to-anything (V2X) communication in a server on a network comprises receiving a certificate issue request including vehicle identification information and road-side unit (RSU) identification information from an RSU. Log information for the certificate issue request is extracted from a database. Normality or abnormality is determined according to whether a predetermined certificate issue criteria is satisfied by analyzing the certificate issue request and the log information. The certificate is issued, and the certificate is transmitted to a vehicle communication module according to determination of normality, or certificate revocation information is registered according to determination of abnormality.

The RSU may receive the vehicle identification information for requesting the certificate issue request from the vehicle communication module supporting wireless access in a vehicular environment (WAVE) communication.

The log information may include whether a certificate signing request (CSR) certificate corresponding to the vehicle identification information is issued or certificate of the log information, an RSU position for the certificate issue request, or a certificate issue request time.

The certificate issue criteria may include whether the corresponding issue request is correct, whether an RSU position is suitable, or whether a certificate issue request time in a corresponding RSU position is adequate.

The step of determining may include determining whether the RSU identification information is registered in the database.

The step of determining may include determining whether a previously issued CSR certificate corresponding to the vehicle identification information exists or it is issued in the log information and verifying whether it is valid.

The step of determining may include determining whether the certificate issue request is an issue request after a predetermined time or more is elapsed since a previous issue request time by referring to the log information.

The step of determining may include determining whether a corresponding RSU position for the certificate issue request is suitable by referring to the log information.

The step of determining may include determining whether a certificate issue request time in a corresponding RSU position for the certificate issue request is adequate.

According to another aspect of the present inventive concept, a system for issuing a reliable certificate to a vehicle for a V2X communication comprises a misbehavior processor configured to receive a certificate issue request including vehicle identification information and RSU identification information from an RSU and to extract log information for the certificate issue request from a database. A misbehavior detection engine is configured to determine normality or abnormality according to whether a predetermined certificate issue criteria is satisfied by analyzing the certificate issue request and the log information. The system issues the certificate and transmits the certificate to a vehicle communication module according to determination of normality, or registers certificate revocation information according to determination of abnormality.

The RSU may receive the vehicle identification information for requesting the certificate issue request from the vehicle communication module supporting a WAVE communication.

The log information may include whether a CSR certificate corresponding to the vehicle identification information is issued or a certificate of the log information, an RSU position requesting the certificate issue, or a certificate issue request time.

The certificate issue criteria may include whether the corresponding issue request is correct, whether an RSU position is suitable, or whether a certificate issue request time is adequate.

The misbehavior detection engine may determine whether the RSU identification information is registered in the database.

The misbehavior detection engine may determine whether a previously issued CSR certificate corresponding to the vehicle identification information exists or it is issued in the log information and verifying whether it is valid.

The misbehavior detection engine may determine whether the certificate issue request is the issue request after a predetermined time or more is elapsed since a previous issue request time by referring to the log information.

The misbehavior detection engine may determine whether a corresponding RSU position for the certificate issue request is suitable by referring to the log information.

The misbehavior detection engine may determine whether a certificate issue request time in a corresponding RSU position for the certificate issue request is adequate.

The system may issue the certificate or register the certificate revocation information in a certificate authority (CA) server of a certificate authority for generating, issuing, and managing the certificate, and transmit the certificate issued from a registration authority (RA) server operated by a registration authority for relaying a certification registration to the vehicle communication module through the RSU.

According to a method and system for detecting misbehavior for a V2X communication, except the function for detecting and reporting misbehavior in a vehicle (local validation), by providing a method for actively detecting an attack in a server, a safe communication environment can be provided. In addition, by introducing a pattern recognition technique of items, such as a request time, a place, and the like, for an anonymous certification issue to misbehavior detection engine (MDE), active and smart attack detection is possible.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram describing a system for detecting misbehavior for a V2X communication according to an embodiment of the present inventive concept.

FIG. 2 is a flow chart describing the operation of the system for detecting misbehavior of FIG. 1.

FIG. 3 is a diagram describing the jurisdiction relationship of an RSU, a RA server, and a CA server in the system for detecting misbehavior for a V2X communication according to an embodiment of the present inventive concept.

FIG. 4 is a diagram describing a method for analyzing whether an RSU position for a certificate issue request is suitable in the system for detecting misbehavior for a V2X communication according to an embodiment of the present inventive concept.

FIG. 5 is a diagram describing a method for analyzing whether a certificate issue request time in the RSU position for a certificate issue request is suitable in a system for detecting misbehavior for a V2X communication according to an embodiment of the present inventive concept.

### DETAILED DESCRIPTION

Hereinafter, the present disclosure will be described in detail with reference to the drawings. At this time, in each of the drawings, the same components are denoted by the same reference symbols, if possible. Further, detailed descriptions for the previously known features and/or configurations are omitted. In the description below, parts required to understand operations in accordance with various embodiments will be explained in priority, the descriptions for elements, which may obscure the gist of the descriptions, are omitted. It can also be shown schematically some of the elements in the figures are exaggerated or omitted. Not utterly reflect an actual size to the size of each element, so that they are not intended to limit the content that is specified here by the relative size and spacing of the elements drawn in the figure, respectively.

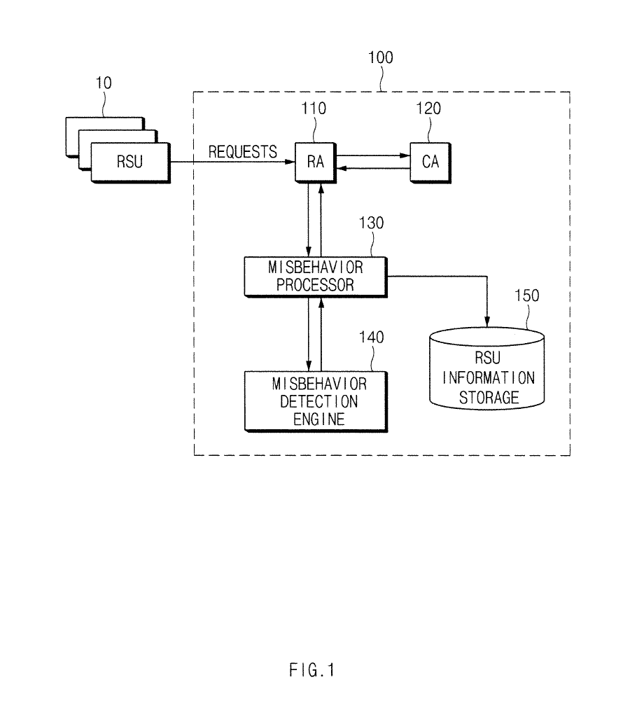

FIG. 1 is a diagram describing a system 100 for detecting misbehavior for a V2X communication according to an embodiment of the present inventive concept.

Referring to FIG. 1, a system 100 for detecting misbehavior according to an embodiment of the present inventive concept may comprise a registration authority (RA) server 110, a certificate authority (CA) server 120, a misbehavior processor 130, a misbehavior detection engine 140, and an RSU information storage 150 of a database type, which are mutually interoperable to actively validate the attack of other vehicles such a dishonest anonymous certificate issue request, etc. and detect misbehavior, by communicating with one or more road-side unit (RSU) 10.

First, the RA sever 110 may be a registrar server such as a financial company (for example, a bank, securities company, and the like) for relaying registration such as generation and issue of a certificate, etc., and CA server 120 may be a server of a certificate authority (for example, Koscom Corp., Korea Information Certificate Authority, Incorporated (KICA), and the like) for generating, issuing, and managing the certificate in order to issue the certificate for each vehicle. However, it is not limited to the above description, in some cases, it may be operated as a server in which the RA sever 110 and the CA server 130 are integrated on a network such as a mobile communication network, Internet, and the like. That is, the system 100 for detecting misbehavior may be formed in one server type.

Further, in the present disclosure, a vehicle comprises a communication module for supporting a vehicle-to-anything (V2X) wireless communication. The vehicle communication module may support mobile communication for such as WCDMA, LTE, WiFi, etc., particularly, through a wireless access in vehicular environment (WAVE) wireless communication method and may support the V2X communication between vehicles with a server on Internet, or with other system or terminal and the like. A WAVE communication protocol, which can be applied to the vehicle communication module, is a combination of IEEE 802.11p standard and IEEE P1609 standard and is used to establish various next-generation intelligent transport systems by supporting inter-vehicle high speed communication and the communication between a vehicle and infrastructure. The WAVE communication method can use the relay of the RSU 10, but it can also support direct communication between vehicles (V2V). The vehicle communication module supporting the WAVE communication method includes a physical layer and a media access control (MAC) layer for supporting communication delay less than 10 msec at a maximum vehicle speed of 200 km/h, a communication radius of 1 km, a maximum transmission speed of 54 Mbps, a frequency of 5.850 - 5.925 GHz, a channel bandwidth of 10 Mhz, a channel number of 7, etc., and ensures high speed mobility.

In the V2X communication environment of the present disclosure, the vehicle communication module can transmit and receive required information by communicating with the RSU 10, the server 110/120, etc. depending on a required signal generation by operation of a user such as driver or other methods. In addition, the vehicle communication module is connected to various human-machine interface (HMI) electronic devices such as a mobile communication terminal (for example, a smart phone, PDA, PMA, etc.), in-vehicle navigation terminal and the like which are utilized by the user, and can transmit and receive the required information by communicating with the RSU 10, the server 110/120, etc. depending on the required signal generation by the operation of the HMI or other methods. Further, it can transmit and receive the required information by communicating with the RSU 10, the server 110/120, etc. depending on the required signal generation by the operation of the user through a user interface which can be provided in the vehicle communication module as requested or other method. The RSU 10 and the server 110/120 can be also interoperated by network such as a mobile communication network or Internet and the like, and as occasion demands, the vehicle communication module can be also interoperated with the RSU 10, the server 110/120, etc. through the network such as a mobile communication network, Internet, or the like.

Generally, a vehicle is manufactured with the vehicle communication module for storing and managing the vehicle identification information such as vehicle identification number (VIN) in a predetermined memory. In order to support the V2X communication by the vehicle communication module, a certificate signing request (CSR) certificate issue (for example, issued annually) issued via the RA server 110, the CA server 120 of the certificate authority must be stored and managed in a memory with management of the above vehicle VIN. A CSR certificate is a certificate for assigning an issue request authority of an anonymous certificate, and the anonymous certificate maintains security such an encryption, etc. and can be issued for authentication, i.e., for every 5 minutes.

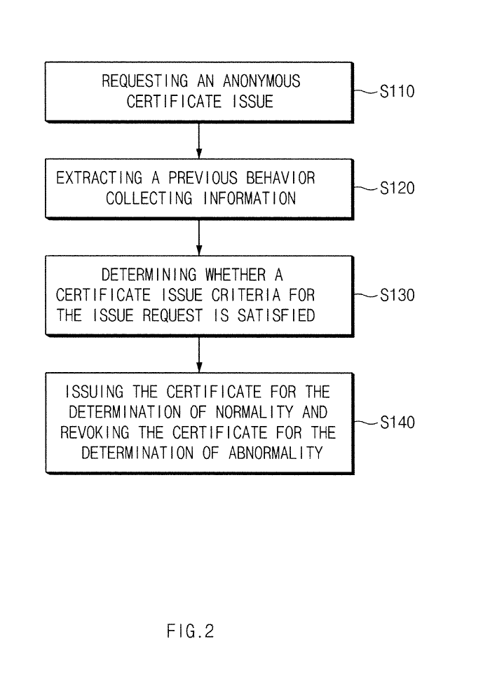

For example, when the system detecting misbehavior for V2X communication of a vehicle is booted, the vehicle communication module requests the issue of the anonymous certificate to the RSU 10. At this time, the RSU 10 transmits the issue request of the anonymous certificate including the vehicle identification information (VIN) and RSU identification information (RSU ID) received from the vehicle communication module to the RA server 110, and the RA server 110 transmits the issue request of the anonymous certification to the misbehavior processor 130 (see S110 of FIG. 2).

The RSU information storage 150 stores log information which is previous behavior collecting information, such as the RSU information (an identifier such as ID, a position, and the like), whether the CSR certificate is issued for the vehicle identification information (VIN) of each vehicle or its certificate, the RSU position requesting the certificate issue, a time requesting the certificate issue, and the like, and in response to the anonymous certificate issue request. Then, the misbehavior processor 130 extracts the previous behavior collecting information, i.e., search information such as the log information, etc. corresponding to the vehicle identification information (VIN) from the RSU information storage 150 and transmits it to the misbehavior detection engine 140 with the anonymous certificate issue request (see S120 of FIG. 2)

The misbehavior detection engine 140 analyzes the anonymous certificate issue request and the search information, determines whether the criteria of the certificate issue is satisfied, such as whether the request is right, whether the RSU position is suitable, whether the time requesting the certificate issue in the RSU position is proper, etc., and transmits the determination result for normality or abnormality to the misbehavior processor 130 (see S130 of FIG. 2). In addition, the misbehavior detection engine 140 may request information required for analysis such as the RSU information (ID, position, etc.) to the misbehavior processor 130, and the misbehavior processor 130 may provide the corresponding search information searched from the RSU information storage 150 to the misbehavior detection engine 140. At this time, as described below, by introducing the pattern recognition method of items for the log information such as whether a certificate is issued, the RSU position, the request time, etc., related to the anonymous certificate issue request, the active and smart attack detection was possible.

The misbehavior processor 130 transmits the above determination result for the normality or abnormality to the RA server 110, and for the normal determination result, enables the anonymous certificate issue between the RA server 110 and CA server 120 to be performed, and for the abnormal determination result, registers it to a certificate revocation list (CRL) in the CA server 120 by the interoperation between the RA server 110 and the CA server 120 and enables the revocation of the CSR certificate to be performed (see S140 of FIG. 2).

For example, with respect to the normal determination result, the RA server 110 is the registrar server such as a financial company (for example, a bank, securities company, and the like), etc. for relaying the registration such as generation and issue of a certificate, etc. of a certificate authority, and enables the CA server 120 to issue and return the corresponding certificate by transmitting a issue request message including the received vehicle identification information (VIN) to the CA server 120. The CA server 120 is a server of the certificate authority (for example, Koscom Corp., KICA Inc., and the like) which processes the request of the certificate issue for each vehicle and manages the issued certificates, and if there is the previously issued CSR certificate corresponding to the vehicle identification information (VIN) of the received issue request message, it issues the corresponding anonymous certificate and transmits it to the RA server 110. The RA server 110 may enable the anonymous certificate to be transmitted to the vehicle communication module via the RSU 10.

With respect to an abnormal determination result, the RA server 110 enables the CA server 120 to revoke a corresponding certificate by transmitting a revocation request message including the received vehicle identification information (VIN) to the CA server 120. The CA server 120 revokes the previously issued CSR certificate corresponding to the vehicle identification information (VIN) of the received revocation message in the database and may register and manage the certificate revocation information such as the vehicle identification information, etc. in the certificate revocation list (CRL).

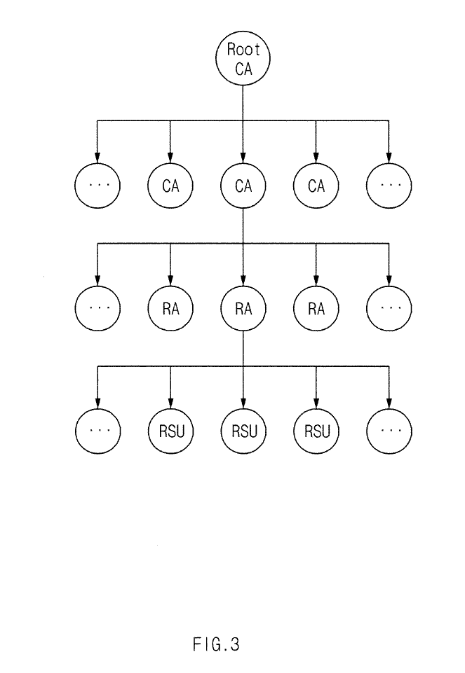

Hereinafter, referring to FIG. 3 to FIG. 5, an analyzing process in the misbehavior detection engine 140 determining whether the criteria of the certificate issue is satisfied in step S130 of FIG. 2 will be described in more detail. If any one or more of the after-mentioned certificate issue criteria are satisfied, the misbehavior detection engine 140 can determine that it is a normal issue request.

The method for analyzing whether the certificate issue request is correct in the misbehavior detection engine 140 may be various as follows.

For example, the misbehavior detection engine 140 may determine whether the received RSU identification information (RSU ID) is the registered ID or not. That is, whether the RSU identification information (RSU ID) is registered can be requested, to the misbehavior processor 130, and the misbehavior processor 130 may determine whether it matches the RSU information stored in the RSU information storage 150 and provide a result to the misbehavior detection engine 140.

The misbehavior detection engine 140 may determine the existence of the CSR certificate or whether it is issued corresponding to the received vehicle identification information (VIN) in the log information received from the misbehavior processor 130 and may verify whether it is valid.

In addition, the misbehavior detection engine 140 may determine whether it is the issue request after a predetermined time (for example, 1 second) or more is elapsed since a previous issue request time by referring to the log information such as the certificate issue request time, etc. corresponding to the vehicle identification information (VIN) received from the misbehavior processor 130.

FIG. 3 is a diagram for explaining the authority relationship of an RSU, a RA server, and a CA server in a system 100 for detecting misbehavior for a V2X communication according to an embodiment of the present inventive concept.

As shown in FIG. 3, a public key infrastructure (PKI) system may be composed of a root CA server such as ‘KISA,’ a plurality of CA servers (for example, Koscom Corp., KICA Inc., and the like) certificated by the root CA server, and a RA server of the registration authority such as a number of financial companies (for example, banks, securities companies, and the like), etc. in which each CA server has jurisdiction, for relaying the issue of a certificate and the like. In the V2X environment, the RSU 10 is disposed in each region of a country, and one RSU performs a given communication with a certain RA server.

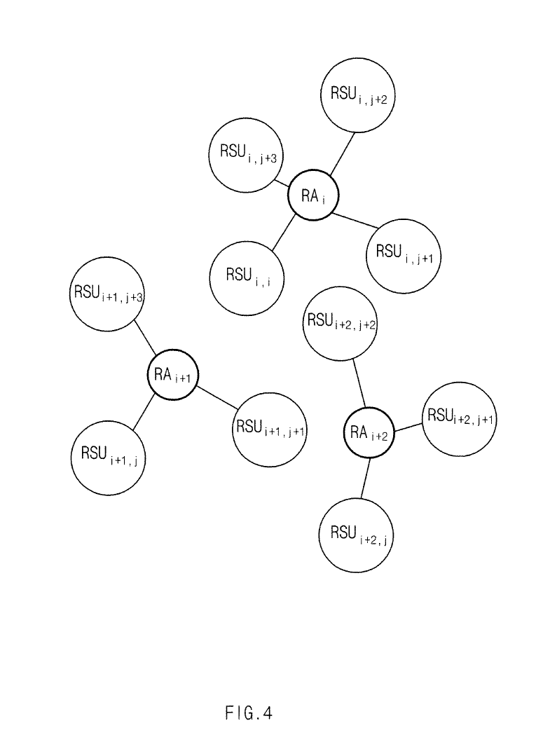

FIG. 4 is a diagram for explaining a method for analyzing whether an RSU position for a certificate issue request is suitable in a system 100 for detecting misbehavior for a V2X communication according to an embodiment of the present inventive concept.

For example, the misbehavior detection engine 140 may determine whether the RSU position (RA server jurisdiction) is suitable for the certificate issue request by referring to the log information such as the RSU position requesting the certificate issue received from the misbehavior processor 130. That is, as shown in FIG. 4, each RSU belongs to the jurisdiction of any one of RA servers 110, and the misbehavior detection engine 140 determines abnormality when the RSU position requesting the certificate issue is other RSU (for example, RSU_{i+1,j} of etc.) position which is not the jurisdiction of its RA server 110 (for example, RAᵢ). In this case, it is determined that an attacker attacks by stealing an ID of another RSU.

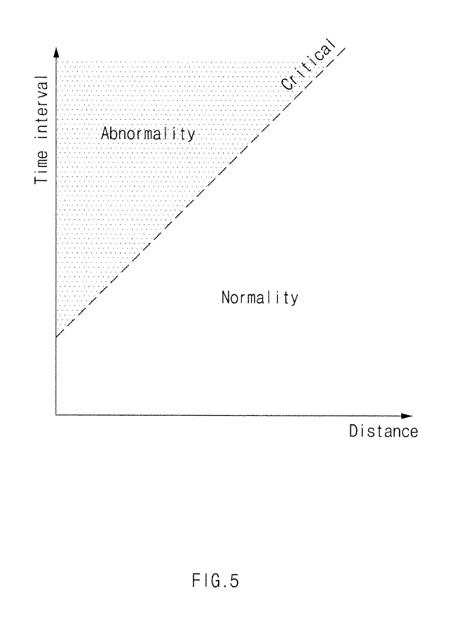

FIG. 5 is a diagram explaining a method for analyzing whether the certificate issue request time in the RSU position for a certificate issue request is suitable in a system 100 for detecting misbehavior for a V2X communication according to an embodiment of the present inventive concept.

The misbehavior detection engine 140 may determine whether the certificate issue request time in the corresponding RSU position for the certificate issue request is suitable by referring to the log information such as the certificate issue request time, etc. corresponding to the vehicle identification information (VIN) received form the misbehavior processor 130.

If the anonymous certificate can be issued over each of a predetermined time interval while the vehicle is moving and an interval of issue request times (Δtᵢ−tᵢ₋₁) and a distance between issue request RSUs (Δd=dᵢ−dᵢ₋₁) conflicts, it is determined that the attacker attacks by stealing the ID of the other RSU.

For example, as shown in FIG. 5, if the time interval (Δt=tᵢ−tᵢ₋₁) smaller than a critical time is calculated for the distance between the RSUs (Δdᵢ−dᵢ₋₁), it can be determined as normal, and otherwise, it is determined as abnormal. If a speed is v=Δd/Δt<v_{c} (v_{c} is a threshold speed), it is determined as normal. The distance between the RSUs (Δd=dᵢ−dᵢ₋₁) may use a previously measured table or may be calculated by transmitting and receiving a predetermined signal and using a transmitting and receiving time.

In the above description, the present inventive concept has been described through specific elements, embodiments, and drawings, it is only provided to assist in a comprehensive understanding of the present disclosure, the present inventive concept is not limited to the embodiments, and it will be understood by those skilled in the art that the present disclosure may be implemented as various modifications and variations without departing from the spirit of the present inventive concept. Accordingly, the scope of the present disclosure is recited in the appended claims, not the above descriptions, and all differences within the equivalent scope of the present disclosure will be construed as being included in the present disclosure.

What is claimed is:

1. A method for issuing a reliable certificate to a vehicle for a vehicle-to-anything (V2X) communication in a server on a network, the method comprising steps of:
(a) receiving a certificate issue request including vehicle identification information and road-side unit (RSU) identification information from an RSU;
(b) extracting log information for the certificate issue request from a database;
(c) determining normality or abnormality according to whether a predetermined certificate issue criteria is satisfied by analyzing the certificate issue request and the log information; and
(d) issuing the certificate and transmitting the certificate to a vehicle communication module according to determination of normality, or registering certificate revocation information according to determination of abnormality.

2. The method according to claim 1, wherein the RSU receives the vehicle identification information for requesting the certificate issue request from the vehicle communication module supporting a wireless access in vehicular environment (WAVE) communication.

3. The method according to claim 1, wherein the log information includes whether a certificate signing request (CSR) certificate corresponding to the vehicle identification information is issued or a certificate of the log information, an RSU position for the certificate issue request, or a certificate issue request time.

4. The method according to claim 1, wherein the certificate issue criteria includes whether the corresponding issue request is correct, whether an RSU position is suitable, or whether a certificate issue request time in a corresponding RSU position is adequate.

5. The method according to claim 1, wherein the step (c) includes a step of determining whether the RSU identification information is registered in the database.

6. The method according to claim 1, wherein the step (c) includes a step of determining whether a previously issued CSR certificate corresponding to the vehicle identification information exists or is issued in the log information and verifying whether it is valid.

7. The method according to claim 1, wherein the step (c) includes a step of determining whether the certificate issue request is an issue request after a predetermined time or more is elapsed since a previous issue request time by referring to the log information.

8. The method according to claim 1, wherein the step (c) includes a step of determining whether a corresponding RSU position for the certificate issue request is suitable by referring to the log information.

9. The method according to claim 1, wherein the step (c) includes a step of determining whether a certificate issue request time in a corresponding RSU position for the certificate issue request is adequate.

10. A system for issuing a reliable certificate to a vehicle for a V2X communication, the system comprising:
a misbehavior processor configured to receive a certificate issue request including vehicle identification information and RSU identification information from an RSU and extract log information for the certificate issue request from a database; and
a misbehavior detection engine configured to determine normality or abnormality according to whether a predetermined certificate issue criteria is satisfied by analyzing the certificate issue request and the log information,
wherein the system issues the certificate and transmits the certificate to a vehicle communication module according to determination of normality, or registers certificate revocation information according to determination of abnormality.

11. The system according to claim 10, wherein the RSU receives the vehicle identification information for requesting the certificate issue request from the vehicle communication module supporting a WAVE communication.

12. The system according to claim 10, wherein the log information includes whether a CSR certificate corresponding to the vehicle identification information is issued or a certificate of the log information, an RSU position requesting the certificate issue, or a certificate issue request time.

13. The system according to claim 10, wherein the certificate issue criteria includes whether the corresponding issue request is correct, whether an RSU position is suitable, or whether a certificate issue request time in a corresponding RSU position is adequate.

14. The system according to claim 10, wherein the misbehavior detection engine determines whether the RSU identification information is registered in the database.

15. The system according to claim 10, wherein the misbehavior detection engine determines whether a previously issued CSR certificate corresponding to the vehicle identification information exists or is issued in the log information and verifies whether the previously issued CSR certificate is valid.

16. The system according to claim 10, wherein the misbehavior detection engine determines whether the certificate issue request is an issue request after a predetermined time or more is elapsed since a previous issue request time by referring to the log information.

17. The system according to claim 10, wherein the misbehavior detection engine determines whether a corresponding RSU position for the certificate issue request is suitable by referring to the log information.

18. The system according to claim 10, wherein the misbehavior detection engine determines whether a certificate issue request time in a corresponding RSU position for the certificate issue request is adequate.

19. The system according to claim 10, wherein the system issues the certificate or registers the certificate revocation information in a certificate authority (CA) server of a certificate authority for generating, issuing, and managing the certificate, and transmits the certificate issued from a registration authority (RA) server operated by a registration authority for relaying a certification registration to the vehicle communication module through the RSU.
